(19) United States
(12) Patent Application Publication
(10) Pub. No.: US 2005/0197959 A1
(43) Pub. Date: Sep. 8, 2005

(54) A method for validating and ordering services and products online

(76) Inventor: Cayetano Sanchez III, East Greenwich, RI (US)

Correspondence Address: CAYETANO SANCHEZ III, 62 ELDREDGE AVENUE, EAST GREENWICH, RI, 02818, US

(21) Appl. No.: 10/708,474

(22) Filed: Mar. 5, 2004

(51) Int. Cl. G06F 17/60

(52) U.S. Cl. 705/44

(57) ABSTRACT

The Digital Order Validation System (DOVS) consists of software combined with validation data to provide a secure method to conduct transactions for photo processing services over a wide area network (e.g. the internet). The invention allows internet based photo processing services and products to be deployed at traditional retail points of sale.

### BACKGROUND OF INVENTION

The present invention relates to a method and system to conduct transactions for photo processing services and products using the internet by allowing consumers to procure said services or products in conjunction with the procurement of related software. For instance the invention can be used to combine digital image management software and validation data such that a member of the public in possession of the software and validation data can conduct an internet based transaction for photographic processing services and products.

Significant changes in the publics' habits and the operations of commercial organizations are underway as a result of the large number of households connected to the internet. The volume of products and services that consumers are procuring via the internet continues to grow. However, concern about security is one obstacle that is slowing the adoption of internet based services and products. Many members of the public are reluctant to transmit information such as credit card data to internet based vendors. Many of these same members of the public would be willing to procure internet based services if such services were available without the need to provide credit card information.

The growing use of digital still cameras is increasing the use of personal computers and the internet by members of the public. Personal computers and the internet are needed to fully appreciate and use the digital images captured by digital cameras. One common use of digital images is to share them via email, which requires both a computer and a network connection.

Digital still cameras are a catalyst for fundamental changes currently underway in the photographic industry. At present digital cameras are outselling film based cameras and industry is deploying equipment and services to continue to spur sales of digital cameras. Two distinct and competing trends are underway in the photographic industry. One is the development and sales of ancillary equipment (e.g., personal computers, image editing software, image management software, and printers) and consumable supplies (photographic quality paper, ink, and storage media) for home based image viewing, sharing, printing, and storage. The other is the deployment of the equipment and associated infrastructure needed to provide services and products at traditional retail outlets. For instance, self-service kiosks are being put in many retail locations to enable consumers to get prints directly from their camera or its memory card without the need for a personal computer at home. Film processing labs are also encouraging consumers to submit their camera's digital memory cards similar to the manner in which exposed film is submitted for traditional processing. Current data indicates that the trend towards home based manipulation and printing of digital images is stronger than the trend to use commercial photographic processing services for digital images.

One impact of digital cameras on the photography industry is the majority of digital images are not printed. Moreover, the vast majority of digital images that are printed are done so at home. Digital images are printed at home for a variety of reasons including perceived convenience and lower cost. Thus, the conversion from film based cameras to digital cameras is also causing a reduction in demand for photo processing services and products from commercial organizations. One result of the growing use of digital cameras is that industry has excess photo processing capacity. Commercial photo processors (e.g., retail stores, camera stores, and photo laboratories) are facing an environment of declining demand for photo processing services and declining revenues and are therefore strongly motivated to find ways to increase demand. Any system that can be used to increase the volume of prints processed by commercial photo processors has a high economic value. An industry wide effort is currently underway to inform consumers of the availability and high quality of photo processing services for digital prints. Many commercial photo processors are also turning to the internet to increase demand. However, security concerns are one obstacle to adoption of internet based photo processing services.

The market for internet based services and products will continue to grow as members of the public continue to become more familiar with the combination of personal computers and consumer electronics, e.g., digital cameras. The invention provides a secure method for consumers to procure services and products over the internet. The invention can be used to deploy simple secure solutions that will be readily adopted by members of the public. The invention also provides the means to increase demand for photo processing services by enabling sales of internet based services and products at the retail point of sale.

### SUMMARY OF INVENTION

A secure system for internet based transactions for services and products that includes client software, validation data for each instance of client software, and a validation server. The validation data is produced and then encoded so that it is secure and cannot be easily determined or produced by an outside agent. The validation data may be produced using a variety of methods. For instance, a random number generator may by used to produce validation data. Algorithmic processes may also be used to produce validation data. Standard encryption and decryption methods may also be used to further secure the validation data and hence the security of transactions conducted using the system. The validation data will be used in conjunction with client software and a validation server to authenticate and validate transactions. The validation data may be either separate for each instance of the software or embedded in each instance of the client software. The client software and validation server may also exchange configuration information as part of the validation and transaction process.

In general, in one aspect, the invention features a secure validation method for determining the status (i.e., valid or invalid) of one or more transactions between a client software application and a validation server. The client software and the validation server are located at different nodes on the internet. Validation data will be provided with each instance of client software and will be transmitted to the validation server as part of a transaction. The validation server will evaluate the validation data along with any ancillary data such as a request for a transaction and then accept or reject the transaction.

Implementations of the invention may also include the exchange of configuration information between the client software and the validation server. The configuration data along with the validation data will be used to specify the types of transactions being processed. The configuration data along with the validation data will be evaluated by the validation server and used to manage the processing of transactions for each instance of client software.

The validation data may or may not be unique for each instance of client software. If non-unique validation data is used, the configuration data exchanged between the client software and validation server may be used to further determine the status of the transaction as well as to further specify a transaction.

### BRIEF DESCRIPTION OF DRAWINGS

FIG. 1 illustrates the components of the digital order validation system.

FIG. 2 illustrates the invention used to implement a digital image order system for photo processing transactions.

FIG. 3 illustrates the transaction for a photo processing digital image order system.

### DETAILED DESCRIPTION

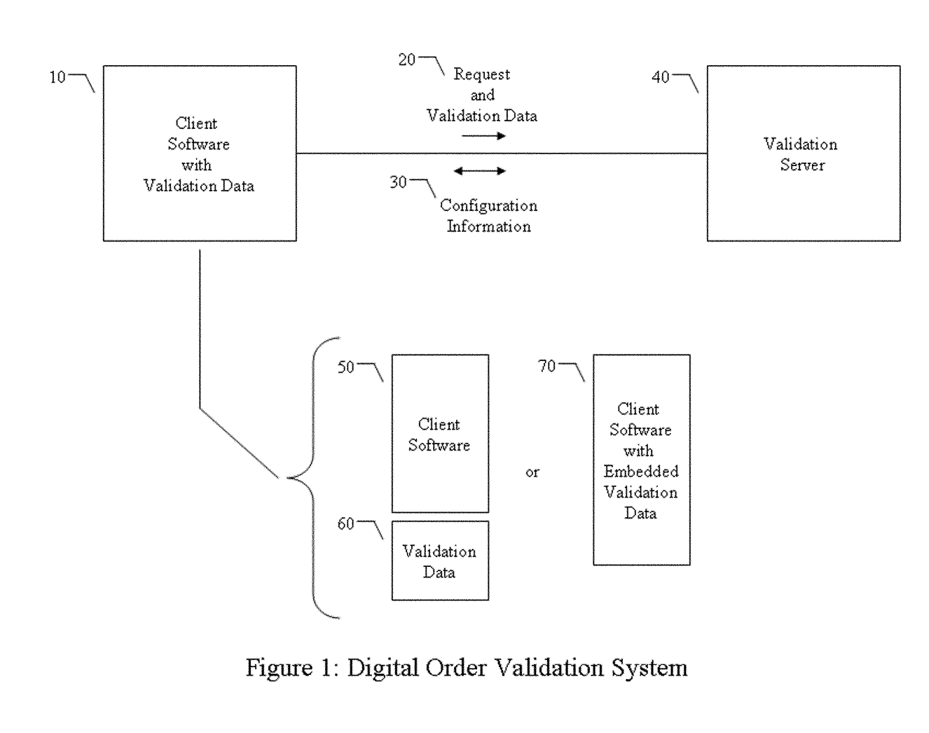

The present invention describes a transaction method that provides for stringent integrity and security of network based transactions for services and products. Referring to FIG. 1, the digital order validation system consists of client software with validation data 10 in one location that will conduct a transaction with a validation server 40 at another location. The client software with validation data 10 may consist of separate client software 50 and validation data 60 or may be configured such that the client software with validation data 10 consists of client software with embedded validation data 70. If the validation data 60 is separate from the client software 50, the validation data 60 may be physically included on the same media as the software or may be provided with physically separate media. For example, the validation data 60 could be provided in the product packaging. If provided separately, the validation data 60 may be hidden using a technique such as a latex covering similar to that used to hide information for other products. For instance, latex coverings are commonly used to hide the Personal ID number (PIN) used for commercially available telephone calling cards.

Referring to FIG. 1, the client software with validation data 10 will initiate a transaction by sending request and validation data 20 to the validation server 40. Configuration information 30 may also be exchanged between the validation server 40 and client software with validation data 10 as part of the transaction validation process. The validation server 40 will evaluate the request and validation data 20 and configuration information 10 if present to determine if the transaction is valid. If the transaction is valid, the validation server 40 will proceed with the transaction by sending configuration information 30 to the client software with validation data 10 to indicate the transaction is valid and that the transaction should be continued. The client software with validation data 10 may also send additional configuration information 30 in response to the configuration information 30 sent by the validation server 40. If the validation server 40 determines that the transaction is not valid, configuration information 30 may be sent to the client software with validation data 10 to indicate that the transaction is not valid. Alternatively, the validation server 40 might simply ignore any request and validation data 20 that it determines to be invalid and require that the client software with validation data 10 determine that its request and validation data 20 has been declined. One way this could happen is for the client software with validation data 10 to use a timeout function.

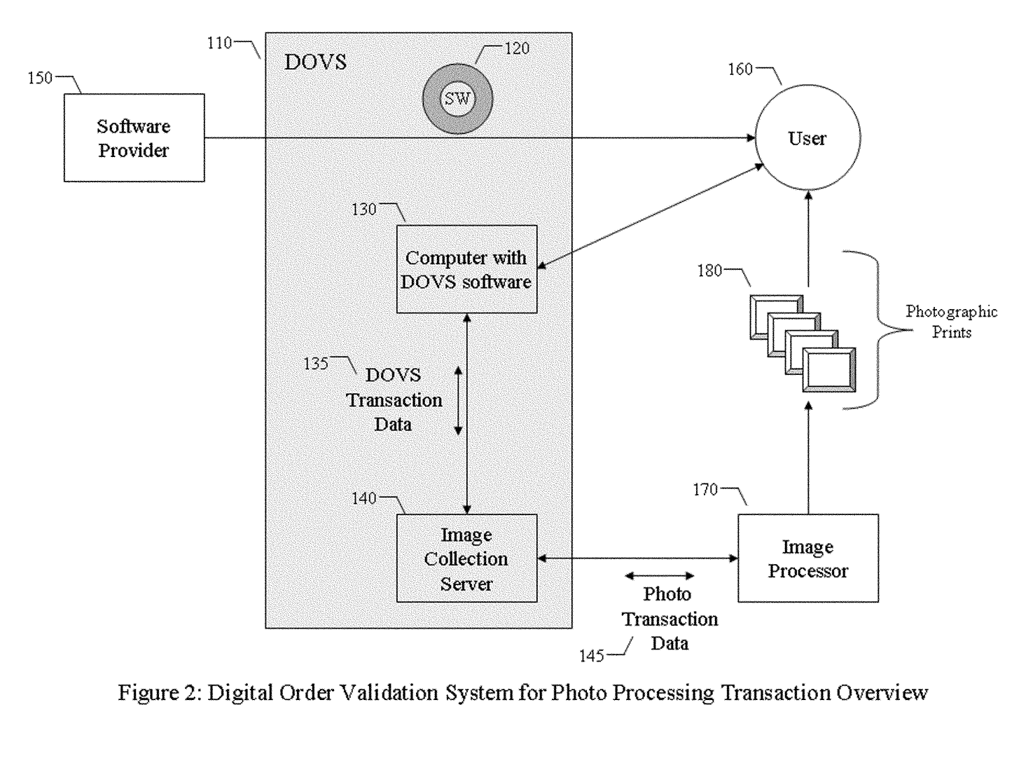

Systems for a wide variety of transactions can be implemented using the digital order validation system. FIG. 2 illustrates the implementation of a system for ordering services and products related to photographic processing for digital images. Referring to FIG. 2 the DOVS 110 (i.e., the Digital Order Validation System) consists of the SW 120, a computer with DOVS software 130, and an image collection server 140. The computer with DOVS software 130 is also assumed to contain digital images for which the user 160 desires a photographic print. SW 120 is shown in FIG. 2 as a distinct item to illustrate its use in the end to end system flow. The SW 120 consists of both client software and validation data. The computer with DOVS software 130 in FIG. 2 is equivalent to the client software with validation data 10 shown in FIG. 1. It is a computer on which the SW 120 will be executed. The image collection server 140 shown in FIG. 2 is equivalent to the validation server 40 shown in FIG. 1. The image collection server 140 will validate transactions for photographic processing services and products.

FIG. 2 illustrates the end to end flow of transactions for the digital order validation system as implemented for a photo processing transaction. Referring to FIG. 2, the flow starts when the software provider 150 supplies SW 120 to a user 160. The user 160 executes the SW 120 on the computer with DOVS software 130. The computer with DOVS 130 initiates a transaction for digital image photographic processing with the image collection server 140. DOVS transaction data 135 is exchanged between the computer with DOVS 130 and image collection server 140 as part of the transaction. The DOVS transaction data 135 includes validation data, configuration information, and digital images. If the transaction is not valid, the image collection server 140 will reject the transaction and send the appropriate response in the DOVS transaction data 135 to the computer with DOVS software 130. After a valid transaction the image collection server 140 and the image processor 170 will exchange photo transaction data 145. As part of the exchange of photo transaction data 145, digital images will be sent to the image processor 170 for processing. The photo transaction data 145 includes additional information needed to manage photographic processing services. After the image collection server 140 interacts with the image processor 170, the image processor 170 produces the photographic prints 180. After the printing is complete, the photographic prints 180 are sent to the user 160 using the appropriate means. For instance, the photographic prints 180 might be sent to the user 160 via the United States Postal Service or via a commercial carrier.

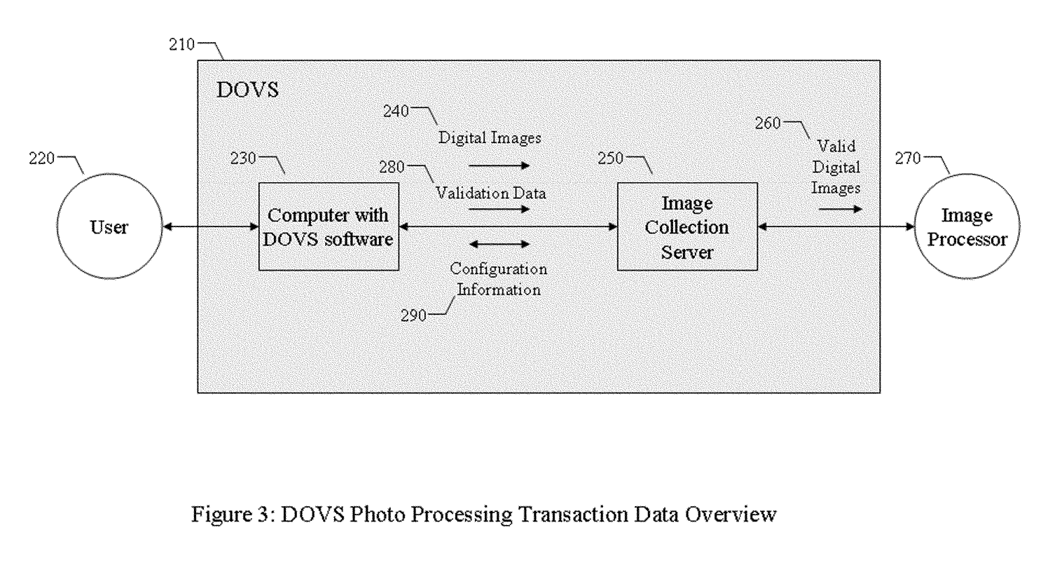

FIG. 3 illustrates a transaction using DOVS 210 for photographic processing services. The components of the DOVS 210 are shown in the shaded box and consist of a computer with DOVS software 230, validation data 280, digital images 240, configuration information 290, an image collection server 250 and valid digital images 260. The user 220 and the image processor 270 interact with elements of the DOVS 210 but are not part of the DOVS 210. The user 220 who desires to transfer digital images 240 for photographic processing initiates the transaction processing by running the applicable software on the computer with DOVS software 230. The computer with DOVS software 230 sends validation data 280 to the image collection server 250. The image collection server 250 evaluates that validation data 280 and determines the transaction status. If the transaction status is valid, the image collection server 250 sends configuration information 290 to the computer with DOVS software 230 to signal acceptance of the requested transaction. After receiving the response from the image collection server 250, the computer with DOVS software 230 will transmit the digital images 240 to the image collection server 250. Configuration information 290 may be exchanged between the computer with DOVS software 230 and the image collection server 250 multiple times as part of the transaction processing to further specify the parameters of the transaction. After the image collection server 250 has received the digital images 240, it will process them and transmit valid digital images 260 to the image processor 270 where they will be printed or processed as appropriate.

The present invention provides an improved validation process for internet based transactions for photo processing services and products by providing a secure method that also limits a consumer's monetary exposure to the cost of the software used to access the said services. Consumers who might be reluctant to use a credit card for an internet transaction because of security concerns (e.g., the potential for identify theft) would be more inclined to use the invention to procure services or products over the internet. Moreover, the invention provides a method for service providers and product vendors to internet based items at traditional retail channels. This feature enables service providers and product vendors to increase demand for their services and products by capturing impulse sales at traditional retail locations.

Service providers and product vendors can also use the invention to create alternative channels for managing photographic processing capacity. For instance, a photo lab could sell photographic processing services at a discount to a volume reseller which in turn would use the invention to offer photographic processing services to consumers at retail points of sale. Selling bulk photographic processing services would enable a photo lab to better utilize its capital photo processing equipment. Alternatively, a retail organization consisting of a single or multiple stores could use the invention to manage its own inhouse photographic processing capacity.

The invention also provides a method to limit the exposure of a vendor when selling photographic processing services and products. A vendor could use time constrained validation data to limit the period for which photographic processing services are available to the consumer. One such use of the invention is to sell client software combined with a time limited validation data as part of a promotion that includes a limited time offer for photographic processing services.

The invention offers the means to introduce new products and services to the market while limiting the total cost of such promotional services by limiting the number of samples redeemed using the validation data and validation server. Moreover, by using validation that is time constrained or otherwise limited (e.g., valid for the first thousand respondents) the invention can be used to manage the overall cost of a promotion. Consumers who are interested in the services and products being promoted would use the software to express their interest. Furthermore, a company can use the invention to gain a cost advantage if the cost of deploying the invention as a promotion to a large number of consumers is less than the cost of deploying product samples to the same number of consumers.

It should be appreciated that the invention can be used to provide a presence for a wide variety of internet based services and products at traditional retail points of sale. Moreover, the invention can be used for services and physical products that are not normally associated with the internet. For example, the invention could be used such that a member of the public in possession of networking software and the associated validation data can conduct transactions to acquire digital data products.

1. A method for conducting online transactions comprising:
combining software with validation data and configuration information such that each instance of said software, validation data, and configuration information can be used to conduct one or more online transactions,
executing said software on a plurality of computers,
exchanging said validation data, and exchanging said configuration information across a network with at least one other computer to validate said transactions,
using said validation data and said configuration information to manage said transactions,
conducting said transactions to access services, and
conducting said transactions to access products.

2. A system of claim 1 consisting of client software and validation data that is resident on one or more computers that can be used to transmit digital images, exchange validation data, and exchange configuration information to one or more image collection servers via a network connection for photo processing by one or more photo processing facilities.

3. A system of claim 2 wherein client software exchanges validation data with one or more image collection servers for the purposes of validating one or more transactions.

4. A system of claim 2 wherein client software exchanges validation data and configuration information with one or more image collection servers for the purposes of identifying the photo processing services and products included in one or more transactions.

5. A system of claim 2 wherein digital images are securely transmitted to one or more image collection servers as part of one or more transactions.

6. A system of claim 2 wherein digital images are transmitted in the clear to one or more image collection servers as part of one or more transactions.

7. A system of claim 2 wherein one or more image collection servers manages one or more transactions for client software using the validation data and configuration information data.

8. A system of claim 2 wherein the validation data is unique for each instance of client software produced and can be used to validate one or more transactions for photo processing services and products.

9. A system of claim 2 wherein the validation data is not unique for each instance of client software produced but may be combined with configuration information and can be used for one or more transactions for photo processing services and products.

10. A system of claim 2 wherein the validation data can be provided to the user of the software separately and be used in conjunction with the client software to manage the number or type of transactions available to an instance of client software for photo processing services and products.
